(19) United States
(12) Patent Application Publication
(10) Pub. No.: US 2016/0023950 A1
(43) Pub. Date: Jan. 28, 2016

(54) Stable Sprayed Concrete Accelerator Dispersion Having A High Active Substance Content

(71) Applicant: Construction Research & Technology GmbH, Trostberg (DE)

(72) Inventor: Martin WEIBEL, Zurich (CH)

(21) Appl. No.: 14/872,414

(22) Filed: Oct. 1, 2015

Related U.S. Application Data
(63) Continuation of application No. 12/307,893, filed on Jul. 8, 2009, now abandoned.

(30) Foreign Application Priority Data
Jul. 14, 2006 (EP) 06014696.6

(51) Int. Cl. C04B 22/14; C04B 28/04; C04B 24/04; C04B 22/06; C04B 24/12

(52) U.S. Cl. CPC C04B 22/148; C04B 22/06; C04B 24/122; C04B 24/04; C04B 28/04

(57) ABSTRACT

Accelerator for sprayed concrete or sprayed mortar, which is present as an aqueous dispersion which contains 25 to 40% by weight of aluminium sulphate and at least one further aluminium compound, so that the molar ratio of aluminium to sulphate in the dispersion is from 1.35 to 0.70, the aqueous dispersion having an inorganic stabilizer which comprises a magnesium silicate.

This application is a continuation application of U.S. Ser. No. 12/307,893, filed 7 Jan. 2009, which is a national stage application of International Application No. PCT/EP2007/001648, filed 27 Feb. 2007, which claims the benefit of Application No. EP06014696.6, filed 14 Jul. 2006, from which application priority is claimed.

### DESCRIPTION

The invention relates to an accelerator for sprayed concrete or sprayed mortar, the use thereof in sprayed concrete or sprayed mortar in the wet and dry spray process and a concrete or mortar layer hardened by the accelerator.

Sprayed concrete and sprayed mortar which is applied to substrates, such as rock surfaces of tunnels, must set and harden rapidly so that the adhesion thereof and hence safety are ensured. For this reason, accelerators which ensure rapid hardening are added to the sprayed concrete or sprayed mortar.

In the past, strongly alkaline accelerators were typically used, alkali-free accelerators generally having become established today, in particular because of the safer handling properties and a resultant better concrete or mortar quality. The alkali-free accelerators may be present both in the form of a dispersion and in the form of a solution. What is important is that said dispersions or solutions firstly have a high active substance content and secondly are sufficiently stable—i.e. dispersed or dissolved active substance does not settle out and dissolved accelerator components do not precipitate, crystallize or gel.

In particular, EP 1 114 004 B1 discloses accelerator solutions having a high active substance content, which employ aluminium sulphate, aluminium hydroxide and carboxylic acids.

WO 2006/010407 discloses both accelerator solutions and accelerator dispersions having a high active substance content, which employ aluminium sulphate and carboxylic acids and optionally further aluminium compounds. The carboxylic acids are used in order to ensure the stability of the accelerators.

EP 0 812 812 B1 discloses alkali-free accelerator dispersions having a high active substance content, which employ aluminium sulphate and at least one alkanolamine in the absence of aluminium hydroxide. These dispersions may contain an inorganic stabilizer which comprises a magnesium silicate.

Aluminium hydroxide is used in the conventional accelerators in relatively large amounts of more than 10% by weight. This has the disadvantage of high costs for such accelerators since aluminium hydroxide is as a rule the most expensive ingredient among the inorganic constituents.

Large amounts of acids and alkanolamines have the disadvantage that, owing to the fact that they can be washed out, the environment, in particular bodies of water, may be polluted. High contents of carboxylic acids are also disadvantageous owing to their costs.

Furthermore, it has been found in practice that, with the use of a commercially available accelerator dispersion having a high active substance content, which employs aluminium sulphate and diethanolamine, in the sprayed concrete obtained, useable strengths are achieved after a few hours and especially after several days (final strength), but the setting behaviour and the early strength in the period up to one hour can be further improved.

In contrast, rapid setting behaviour and good early strength can be achieved with a commercially available accelerator solution having a high active substance content, which employs aluminium sulphate, aluminium hydroxide and a carboxylic acid, when used in sprayed concrete, but the strength after a few hours and after days can be further improved.

It is therefore an object of the present invention to provide an accelerator which eliminates the disadvantages from the prior art and, in particular compared with the known accelerators, exhibits rapid setting behaviour and very good early strength, preferably a compressive strength of sprayed concrete of more than 0.3 MPa after 15 min and/or more than 0.60 MPa after 1 h and very good strength after a few hours, preferably a compressive strength of sprayed concrete and sprayed mortar of more than 2 MPA after 6 h and/or more than 15 MPa after 24 h and, especially after several days, preferably a compressive strength of sprayed concrete and sprayed mortar of more than 40 MPa after 7 days and/or more than 50 MPa after 28 days, and additionally has sufficient stability preferably of more than 3 months.

Rapid setting and a very good early strength are of major importance particularly in the case of loose rock and water penetration and wherever rapid progress of construction has financial and logistical advantages. This is because they offer sufficient protection at an earlier stage, for example from falling stones, and thus enable the next construction stage, for example drilling of holes or a subsequent explosion, to be implemented more quickly.

This object is achieved by an accelerator for sprayed concrete or sprayed mortar according to claim 1, which is present as an aqueous dispersion which contains 25 to 40% by weight of aluminium sulphate in at least one further aluminium compound, so that the molar ratio of aluminium to sulphate in the dispersion is from 1.35 to 0.70, the aqueous dispersion having an anionic stabilizer which comprises a magnesium silicate.

Further preferred embodiments of the invention are defined in the further claims.

The 25 to 40% by weight of aluminium sulphate present in the accelerator are present partly in dispersed form and partly in dissolved form. Frequently, at least a portion of the aluminium sulphate reacts with other components of the dispersion (e.g. with aluminium hydroxide) with formation of complicated aluminium complexes. Thus, as a rule, at least a portion of the dissolved aluminium sulphate is present in the form of these complex structures. The basis for the statement of the aluminium sulphate content (% by weight of aluminium sulphate) is the total proportion of sulphate (if 3 mol of sulphate are present, 1 mol of aluminium sulphate is present) in the dispersion. The statement 25 to 40% by weight of aluminium sulphate is based on anhydrous aluminium sulphate. In practice, however, water-containing aluminium sulphate, e.g. having an aluminium content according to “17% of Al₂O₃”, is as a rule used. The addition of the at least one further aluminium compound increases the proportion of aluminium in the dispersion compared with the proportion of sulphate, so that the molar ratio of aluminium to sulphate in the dispersion is correspondingly greater than in the case of aluminium sulphate (2:3). In addition to the aluminium sulphate, further sulphate-containing compounds may also be present in the dispersion, but the total molar ratio of aluminium to sulphate in the dispersion is always between 1.35 and 0.70.

Components which inhibit or prevent the dispersed particles of the accelerator according to the invention from settling out are suitable as the inorganic stabilizer which comprises a magnesium silicate. In a particularly preferred embodiment of the invention, the aqueous dispersion has an inorganic stabilizer which comprises or is sepiolite. Particularly preferably the dispersion according to the invention contains the inorganic stabilizer in a proportion of 0.1 to 10% by weight. Even more preferred stabilizer contents are in the range from 0.2 to 3% by weight and especially in the range from 0.3 to 1.3% by weight.

Sepiolite is a hydrated magnesium sulphate which is frequently shown in the literature with the empirical formula

Si₁₂Mg₈O₃₀(OH)₄(OH₂)₈.8H₂O

or Mg₄Si₆O₁₅(OH)₂.6H₂O

and, like the other clays, belongs to the group consisting of the phyllosilicates. Sepiolite is composed of 2 layers of tetrahedral silica which are linked via oxygen atoms to an octahedral, non-cohesive middle layer comprising magnesium atoms. This structure imparts a microfibrous morphology to the sepiolite particles. A plurality of products of inorganic stabilizers which are suitable for the present invention and comprise sepiolite are commercially available—e.g. “Pangel” from Tolsa.

Pangel is a rheological additive which is obtained from sepiolite by loosening the fibre bundles and detaching the particles without destroying the particular, elongated shape thereof.

By definition, the inorganic stabilizers suitable for the invention are to be understood as meaning in particular products which are obtained as such via modification methods directly from the particularly preferred sepiolite, such as, for example, said “Pangel”, the modification measures at least substantially preserving the elongated shape of the sepiolite particles. The modification measures meant in this context preferably relate to the loosening of sepiolite as such and measures for detaching sepiolite particles. An example of such a modification measure is the wet milling of sepiolite as such.

In addition to the inorganic stabilizer which comprises a magnesium silicate, a further inorganic stabilizer may also be present in the accelerator according to the invention. Certain clay minerals, e.g. bentonites, certain kaolins and very generally inert thixotropic substances are suitable. An example of this is Tixoton® from Süd-Chemie, which is based on bentonite. This further inorganic stabilizer may be present in the accelerator according to the invention in an amount of 0.1 to 15% by weight, preferably 0.2 to 5% by weight, more preferably 0.3 to 2.5% by weight.

The accelerator according to the invention ensures excellent strength development—in particular very good early strength (strength after 0 to 1 hour) and very good strength after a few hours (strength from 6 to 24 hours) and final strength (strength from 7 days onwards). The added inorganic stabilizer, in particular sepiolite, is capable of protecting the high proportion of the dispersed aluminium sulphate from sedimentation and compaction over many months. Irreversible crystallization, as may occur in the case of accelerator solutions, is ruled out. The accelerator according to the invention is therefore not only highly effective but also particularly stable during storage.

The sprayed concrete accelerator usually contains about 1 to 13% by weight, preferably less than 10% by weight, particularly preferably 2 to 8% by weight, of the at least one further aluminium compound, more preferably less than 7% by weight, most preferably 2 to 6% by weight and advantageously less than 5% by weight (certain variations are possible depending on the quality of the aluminium compound).

In a particularly advantageous embodiment of the invention, the at least one further aluminium compound is water-soluble, at least at a pH of 1 to 5, preferably of 2 to 3.5. It is preferably present as aluminium hydroxide, particularly preferably as amorphous aluminium hydroxide. In practice, industrial aluminium hydroxide, which, in addition to about 80% by weight of pure amorphous aluminium hydroxide, may also contain in particular sulphates, carbonates and especially water, is frequently used instead of pure (dry) amorphous aluminium hydroxide.

Since the accelerator according to the invention does not reach a pH outside from 1 to 5 either during preparation or during storage, any aluminium present in the stabilizer remains chemically bound and is not taken into account in the stated amounts of aluminium in this patent application. It has no influence, or no substantial influence, on the accelerator effect even later on in the concrete or mortar. The high pH of typically 12 to 13 prevailing there leads to no more, or not substantial, release of aluminium from the stabilizer, in particular in the decisive first hours and days.

In a preferred embodiment, the accelerator contains 28 to 39% by weight, particularly preferably more than 32% by weight and up to 37% by weight of aluminium sulphate. A preferred molar ratio of aluminium to sulphate of from 1.05 to 0.70, particularly preferably from 0.94 to 0.74, results.

These ratios are particularly preferred since the accelerator according to the invention leads to very good setting times and strengths and is substantially more economical than the conventional accelerators which employ the expensive aluminium hydroxide in large proportions of more than 10% by weight.

The accelerator can particularly advantageously have a content of 0.2 to 3% by weight of the inorganic stabilizer which comprises a magnesium silicate, preferably sepiolite, a proportion of 0.3 to 1.3% by weight having proved particularly useful, since not only effective stabilization of the dispersion but also an advantageous viscosity of the sprayed concrete accelerator results when this range is maintained. In a wide range of the amounts of aluminium and sulphate stated here, the viscosity is below 2000 mPa·s at 20° C., often in the particularly advantageous range below 1000 mPa·s at 20° C.

Particularly preferably, the aqueous dispersion is present as an aqueous suspension.

The sprayed concrete accelerator according to the invention may also contain further additives, such as one or more alkanolamine(s), e.g. triethanolamine and/or diethanolamine, and one or more carboxylic acid(s) such as dicarboxylic acid(s), (e.g. oxalic acid) and/or monocarboxylic acid(s) (e.g. formic acid). As a result, the stability during storage, the viscosity and the accelerator effect can be improved.

By using alkanolamine, preferably diethanolamine, in addition to aluminium sulphate and aluminium hydroxide and optionally a further inorganic stabilizer, particularly good acceleration can be achieved, which manifests itself in rapid setting and good strength.

In a further advantageous embodiment of the invention, the accelerator contains only a small proportion of carboxylic acid, preferably less than 1% by weight of carboxylic acid, or preferably no carboxylic acid at all. This has the advantage that a particularly economical product can be provided since the carboxylic acid increases the raw material costs but is not required for sufficient stability and acceleration in an accelerator according to the invention. Furthermore, as a result of the smaller proportion of carboxylic acid or by dispensing with said carboxylic acid, the environmental pollution due to washed-out acid is reduced.

Advantageous embodiments of the accelerator of the invention contain 2 to 6% by weight of alkanolamine, preferably diethanolamine. Particularly preferably, such accelerators contain 2 to 6% by weight of aluminium hydroxide, it being most preferred if the total proportion of alkanolamine and aluminium hydroxide is less than 10% by weight. It is thus possible to provide an economical and better accelerator which contains the expensive inorganic ingredient aluminium hydroxide in only a small proportion and thus cuts costs, while outstanding strengths in combination with improved setting are achieved in a mortar or concrete.

In a further advantageous embodiment of the invention, the accelerator contains only a small proportion of alkanolamine, e.g. less than 4% by weight, preferably less than 2% by weight, of alkanolamine, more preferably no alkanolamine at all.

This has the advantage that a particularly environmentally friendly product can be provided since alkanolamines, especially diethanolamine, may harm water organisms but are not required for sufficient stability and acceleration in an accelerator according to the invention.

The invention furthermore relates to the use of the accelerator described above in the coating of substrates, in particular tunnel surfaces, mine surfaces, construction trenches, shafts, etc., with concrete or mortar.

Typically, 5 to 10 kg of the accelerator according to the invention are used in practice per 100 kg of cement.

The invention furthermore relates to a hardened layer of concrete or mortar which was produced by applying sprayed concrete or sprayed mortar, the hardening of which was forced with an accelerator described above.

Below, the present invention is to be explained in more detail with reference to working examples:

Preparation of the accelerators A and B according to the invention:

Water is initially introduced and then Pangel S9, aluminium sulphate, diethanolamine and aluminium hydroxide are added in succession according to the table below with stirring. Thereafter, stirring is effected for eight hours and the mixture is allowed to stand overnight. On the next morning and on the following evening, the mixture is stirred up each time. It is once again allowed to stand overnight and is stirred up again on the following morning, resulting in a homogeneous dispersion which is stable for at least three months. The above process is carried out at room temperature.

| Starting components | | |
|---|---|---|
| (data in kg) | Accelerator A | Accelerator B |
| Water | 58.5 | 58.9 |
| Pangel S9 | 0.7 | 0.7 |
| Aluminium sulphate | 34.8 | 36.4 |
| Diethanolamine | 2 | 2 |
| Aluminium hydroxide | 4 | 2 |

The amounts stated above relate to the proportions of the components by mass, it being assumed that the components are present in pure form. In reality, however, instead of pure components, industrial components which still contain in particular water are used. This means that correspondingly more (than stated in the above table) of the industrial components are used. Regarding the industrial components used:
Water
Pangel S9
Aluminium sulphate: water-containing/17% of Al₂O₃; granulated and milled
Diethanolamine: 90%
Aluminium hydroxide: 76.8% by weight content of pure aluminium hydroxide, up to about 4% of carbonates, remainder substantially water

For comparison, two commercially available accelerators C and D are tested.

The accelerator C is an accelerator dispersion having a high active substance content, which employs aluminium sulphate and diethanolamine.

The accelerator D is an accelerator solution having a high active substance content, which employs aluminium sulphate and a larger amount of more than 10% by weight of aluminium hydroxide and a carboxylic acid.

### Strength Test:

Accelerator/cement ratio: 7% (7 kg per 100 kg of cement)
Cement used: US type I Lafarge Alpena (USA)

Concrete

| Cement | US Type I Lafarge Alpena | |
|---|---|---|
| Water/cement ratio | | 0.44 |
| Sand type A | 0-4 mm | 70% [%] |
| Sand type B | 4-8 mm | 30% [%] |
| Plasticizer | Glenium ® 3030N5 (USA) | 0.85 [%] |
| Retardant | Delvo ®Crete Stabilizer (USA) | 0.95 [%] |

The stated percentages in the case of the plasticizer and retardant are based on the cement weight.

Strength-measuring method: EFNARC European Directive for sprayed concrete 1999

### Strength Values:

Dose

| | | | | |
|---|---|---|---|---|
| Accelerator A | 7% | | | |
| Accelerator B | | 7% | | |
| Accelerator C | | | 7% | |
| Accelerator D | | | | 7% |

Compressive strength

| | | | | | | | |
|---|---|---|---|---|---|---|---|
| 6 | min | Meyco ® | [N/mm²] | 0.23 | 0.20 | 0.15 | 0.44 |
| | | Needle | | | | | |
| 15 | min | Meyco ® | [N/mm²] | 0.34 | 0.39 | 0.23 | 0.57 |
| | | Needle | | | | | |
| 30 | min | Meyco ® | [N/mm²] | 0.45 | 0.48 | 0.32 | 0.66 |
| | | Needle | | | | | |
| 1 | h | Meyco ® | [N/mm²] | 0.65 | 0.64 | 0.60 | 0.86 |
| | | Needle | | | | | |
| 6 | h | Hilti ® Nail | [N/mm²] | 4.83 | 2.82 | 3.59 | 1.51 |
| | | Gun | | | | | |
| 24 | h | Hilti ® Nail | [N/mm²] | 18.63 | 17.06 | 20.93 | 6.46 |
| | | Gun | | | | | |
| 7 | days | drilling core | [N/mm²] | 44.5 | 50.6 | 48.8 | 26.8 |
| 28 | days | drilling core | [N/mm²] | 57.4 | 54.0 | 54.1 | 38.2 |

### Evaluation of the Strength Values

The accelerators A and B according to the invention set substantially more rapidly than the accelerator C, as shown by the higher early strengths. Nevertheless, they subsequently show no strength losses at all, as is otherwise usual. Both after a few days and after 28 days, they reach the same good values as the accelerator C. Even better setting and an even better development of early strength are possible, as shown by accelerator D, but such a good strength and in particular a high final strength are not reached after a few hours.

The accelerators A and B according to the invention therefore surprisingly show that both rapid setting and very good strength are possible over the entire time range. Moreover, the accelerators A and B have outstanding stability of more than 3 months without the use of a carboxylic acid.

The following accelerators E to H are prepared as follows:

The ingredients mentioned in the table below are added to one another in succession and stirred vigorously at 65° C. for 1 hour. Thereafter, the mixture is allowed to cool to room temperature and is again stirred vigorously after 1 week.

| Amount prepared: | | 1 kg | 1 kg | 1 kg | 1 kg |
|---|---|---|---|---|---|
| Composition: | | % | % | % | % |
| Accelerator | | E | F | G | H |
| Ingredient | Content | | | | |
| Water | | 28.3 | 28.3 | 21.3 | 24.3 |
| Pangel S9 | | 0.7 | 0.7 | 0.7 | 0.7 |
| Diethanolamine | 90% | 2 | 4 | 8 | |
| Aluminium sulphate | 96.4% | 65 | 65 | 70 | 69 |
| 16 hydrate | | | | | |
| Aluminium | 76.8% | 4 | 2 | | 6 |
| hydroxide | | | | | |
| Water | 100% | 60.4 | 60.2 | 55.5 | 58.6 |
| Pangel S9 | 100% | 0.7 | 0.7 | 0.7 | 0.7 |
| Diethanolamine | 100% | 1.8 | 3.6 | 7.2 | |
| Aluminium sulphate | 100% | 34.0 | 34.0 | 36.6 | 36.1 |
| Aluminium | 100% | 3.1 | 1.5 | | 4.6 |
| hydroxide | | | | | |
| Al/sulphate | mol/mol | 0.80 | 0.73 | 0.67 | 0.85 |

The accelerators E to H were tested with regard to the setting time and the compressive strength with mortar according to DIN EN 196-1 and -3:

### Mortar

Cement: 450 g of CEM I 42.5 normal 4 Untervaz
Plasticizer: 0.15% (based on cement weight) of Glenium® 51
Retardant: 0.2% (based on cement weight) of Delvo®Crete stabilizer 10
Water/cement ratio (W/C): 0.45
Sand: 1350 g of CEN standard sand

The addition of the accelerator was effected in a proportion of 9 percent by weight, based on the cement weight.

The results of the tests are as follows:

Accelerator

| | | E | F | G | H |
|---|---|---|---|---|---|
| Start of setting | (minutes) | 2.5 | 3.5 | 5.0 | 4.0 |
| End of setting | (minutes) | 12 | 12 | 20 | 14 |
| Compressive | (MPa) | 2.3 | 2.4 | 3.6 | 3.1 |
| strength after 6 | | | | | |
| hours | | | | | |
| Compressive | (MPa) | 24.3 | 25.6 | 29.0 | 27.5 |
| strength after 1 | | | | | |
| day | | | | | |
| Compressive | (MPa) | 40.7 | 41.7 | 48.0 | 47.2 |
| strength after 7 | | | | | |
| days | | | | | |

As is evident from the above results, very good strength values, which are virtually just as good as in the reference accelerator G, which employs no further aluminium compound apart from aluminium sulphate, can be achieved with the accelerators E, F and H, according to the invention, in particular H, but the setting properties are substantially improved compared with this reference accelerator G, especially in the case of the accelerators E and F. This improvement can be achieved with only small amounts of additional aluminium hydroxide. This is surprising compared with the conventional accelerators which employ a very large amount of aluminium hydroxide in an amount of more than 10% by weight and has the advantage that it is possible to provide a very economical accelerator which does not require expensive carboxylic acids and requires the aluminium hydroxide, which is expensive among the inorganic ingredients, only in substantially small amounts. The somewhat lower strengths which are achieved with the accelerators E and F are due to the higher water contents.

The following accelerators I to O are prepared analogously to examples E to H:

| | | Amount prepared: | | | | | |
|---|---|---|---|---|---|---|---|
| | | 1 kg | 1 kg | 1 kg | 1 kg | 1 kg | 1 kg |
| | | Composition: | | | | | |
| | | % | % | % | % | % | % |
| | | Accelerator | | | | | |
| Ingredient | Content | I | K | L | M | N | O |
| Water | | 29.3 | 28.3 | 27.3 | 25.3 | 23.3 | 23.3 |
| Pangel S9 | | 0.7 | 0.7 | 0.7 | 0.7 | 0.7 | 0.7 |
| Aluminium sulphate | 96.4% | 70 | 70 | 70 | 70 | 70 | 68 |
| 16 hydrate | | | | | | | |
| Aluminium | 76.8% | | 1 | 2 | 4 | 6 | 8 |
| hydroxide | | | | | | | |
| Water | 100% | 62.7 | 61.9 | 61.2 | 59.6 | 58.1 | 57.6 |
| Pangel S9 | 100% | 0.7 | 0.7 | 0.7 | 0.7 | 0.7 | 0.7 |
| Aluminium sulphate | 100% | 36.6 | 36.6 | 36.6 | 36.6 | 36.6 | 35.6 |
| Aluminium | 100% | | 0.8 | 1.5 | 3.1 | 4.6 | 6.1 |
| hydroxide | | | | | | | |
| Al/sulphate | mol/mol | 0.67 | 0.70 | 0.73 | 0.79 | 0.85 | 0.92 |

The viscosities were measured using a Brookfield DV-II+viscometer with spindle 4 and 100 revolutions per minute at 20° C.;

Viscosities

| | | | | | | | |
|---|---|---|---|---|---|---|---|
| Average | [mPa · s] | 1028 | 1329 | 1031 | 964 | 1036 | 840 |
| Lower range | [mPa · s] | 796 | 1047 | 848 | 828 | 812 | 660 |
| Upper range | [mPa · s] | 1260 | 1610 | 1214 | 1100 | 1260 | 1020 |

The viscosity values very unexpectedly show that, at a high aluminium sulphate content, the viscosity remains the same if a part of the water is replaced by aluminium hydroxide in the range of 2 to 6% by weight. In the viscosity range which is necessary for practical applications, namely less than 2000 mPa·s, preferably less than 1000 mPa·s, this leads to further improved accelerations in the mortar, which manifests itself in more rapid setting and higher compressive strength.

The accelerators I, L and M were tested with regard to the setting time and the compressive strength with the mortar according to DIN EN 196-1 and -3:

### Mortar

Cement: 450 g of OEM I 42.5 Normo 4 Untervaz
Plasticizer: 0.15% (based on cement weight) of Glenium® 51
Retardant: 0.2% (based on cement weight) of Delvo®Crete Stabilizer 10
Water/cement ratio (W/C): 0.45
Sand: 1350 g of CEN standard sand

The accelerator was added in a proportion of 9% by weight, based on the cement weight.

The results of the tests are as follows:

| | | Accelerator | | |
|---|---|---|---|---|
| | | I | L | M |
| Start of setting | (minutes) | 6.0 | 5.5 | 4.5 |
| End of setting | (minutes) | 25 | 18 | 12 |
| Compressive | (MPa) | 2.6 | 2.8 | 3.2 |
| strength after 6 | | | | |
| hours | | | | |
| Compressive | (MPa) | 28.6 | 26.4 | 26.0 |
| strength after 1 | | | | |
| day | | | | |
| Compressive | (MPa) | 51.1 | 48.7 | 50.1 |
| strength after 7 | | | | |
| days | | | | |

As is evident from the above results, very good strength values which, after 1 to 7 days, are approximately just as good as in reference accelerator I, which employs no further aluminium compound apart from aluminium sulphate, can be achieved with the accelerators L and M according to the invention, but the setting properties are substantially improved compared with this reference accelerator I and the strength values after 6 hours are likewise better. This improvement can be achieved with only small amounts of additional aluminium hydroxide. This is surprising compared with the conventional accelerators which employ a very large amount of aluminium hydroxide in an amount of more than 10% by weight and has the advantage that it is possible to provide a very economical accelerator which requires the aluminium hydroxide, which is expensive among the inorganic ingredients, only in substantially smaller amounts. The accelerators according to the invention furthermore have the further advantage that no organic compounds are present which, because they can be washed out, pollute the environment, in particular water organisms.

The following accelerators P to T are prepared analogously to examples E to H:

| Amount prepared: | | 1 kg | 1 kg | 1 kg | 1 kg |
|---|---|---|---|---|---|
| Composition: | | % | % | % | % |
| Substance | Content | P | Q | S | T |
| Water | 100% | 60.8 | 60.3 | 60.8 | 60.3 |
| Pangel S9 | 100% | 0.5 | 1.0 | | |
| Tixoton ® | 100% | | | 0.5 | 1 |
| Aluminium | 100% | 3.1 | 3.1 | 3.1 | 3.1 |
| hydroxide | | | | | |
| Aluminium sulphate | 100% | 35.6 | 35.6 | 35.6 | 35.6 |

The following starting materials were additionally used:

### Water

Pangel S9
Tixoton®
Aluminium hydroxide 76.8%
Aluminium sulphate 16 hydrate 96.4%

The stabilities and viscosity values were as follows:

| | Accelerator | | | |
|---|---|---|---|---|
| | P | Q | S | T |
| Clear supernatant solution before | 2 | 0 | 6 | 4 |
| stirring up (after 6 days) [%] | | | | |
| Viscosity after vigorous stirring (after | 522 | 580 | 682 | 1004 |
| 1 week) [mPa · s] | | | | |
| Viscosity 1 day later (after 8 days) | 742 | 978 | 852 | 1292 |
| [mPa · s] | | | | |
| Clear supernatant solution 1 month | 2 | 0 | 14 | 8 |
| later (after 6 weeks) [%] | | | | |
| Viscosity after stirring by hand (after 6 | 710 | 908 | 966 | 1302 |
| weeks) [mPa · s] | | | | |

The viscosities were measured using a Brookfield DV- II+viscometer with spindle 4 and 100 revolutions per minute at 20° C.

Tixoton® is a stabilizer based on bentonite. As is evident from the results in relation to the stability and the viscosities, the accelerators P and Q according to the invention, with an inorganic stabilizer which comprises a magnesium silicate, have better stabilities and have viscosities more suitable in practice compared with the comparative accelerators S and T with a bentonite-based stabilizer.

1. An accelerator for sprayed concrete or sprayed mortar, which is present as an aqueous dispersion which consists essentially of the following:
(a) 25 to 40% by weight of aluminium sulphate, based on the total weight of the accelerator,
(b) 1 to 13% by weight of at least one further aluminium compound, so that the molar ratio of aluminium to sulphate in the dispersion is from 1.35 to 0.70,
(c) 0.1 to 10% by weight of an inorganic stabilizer which comprises a magnesium silicate, and
(d) the remainder water.

2. The accelerator according to claim 1, wherein the inorganic stabilizer comprises sepiolite.

3. The accelerator according to claim 1, wherein the at least one further aluminium compound is present in an amount of less than 10% by weight, based on the total weight of the accelerator.

4. The accelerator according to claim 1, wherein the at least one further aluminium compound is water-soluble at least at a pH of 1 to 5.

5. The accelerator according to claim 4, wherein the at least one further aluminium compound is present as amorphous aluminium hydroxide.

6. The accelerator according to claim 1, wherein the aluminium sulphate is present in an amount of 28 to 39% by weight, based on the total weight of the accelerator.

7. The accelerator according to claim 1, wherein the molar ratio of aluminium to sulphate in the dispersion is from 1.05 to 0.70.

8. The accelerator according to claim 1, wherein the dispersion is present in the form of a suspension.

9. An accelerator for sprayed concrete or sprayed mortar, which is present as an aqueous dispersion which consists essentially of the following:
(a) 25 to 40% by weight of aluminium sulphate, based on the total weight of the accelerator,
(b) 1 to 13% by weight of at least one further aluminium compound, so that the molar ratio of aluminium to sulphate in the dispersion is from 1.35 to 0.70,
(c) 0.1 to 10% by weight of an inorganic stabilizer which comprises a magnesium silicate,
(d) 2 to 6% by weight of an alkanolamine, and
(e) the remainder water.

10. An accelerator for sprayed concrete or sprayed mortar, which is present as an aqueous dispersion which consists essentially of the following:
(a) 25 to 40% by weight of aluminium sulphate, based on the total weight of the accelerator,
(b) 1 to 13% by weight of at least one further aluminium compound, so that the molar ratio of aluminium to sulphate in the dispersion is from 1.35 to 0.70,
(c) 0.1 to 10% by weight of an inorganic stabilizer which comprises a magnesium silicate,
(d) less than 1% by weight of a carboxylic acid, and
(e) the remainder water.

11. The accelerator according to claim 10, wherein the carboxylic acid is at least one of oxalic acid or formic acid.

12. A hardened layer which was produced by applying sprayed concrete or sprayed mortar, the hardening of which was forced with an accelerator according to claim 1.

13. The accelerator according to claim 1, wherein the inorganic stabilizer is present in an amount of 0.2 to 3% by weight, based on the total weight of the accelerator.

14. The accelerator according to claim 1, wherein the at least one further aluminium compound is present in an amount of 2 to 6% by weight, based on the total weight of the accelerator.

15. The accelerator according to claim 1, wherein the at least one further aluminium compound is water-soluble at least at a pH of 2 to 3.5.

16. The accelerator according to claim 1, wherein the aluminium sulphate is present in an amount of more than 32% by weight and up to 37% by weight, based on the total weight of the accelerator.

17. The accelerator according to claim 1, wherein the molar ratio of aluminium to sulphate in the dispersion is from 0.94 to 0.74.

18. The accelerator according to claim 9, wherein the alkanolamine is at least one of diethanolamine or triethanolamine.

19. A method of coating a substrate, comprising applying sprayed concrete or sprayed mortar, and forcing the hardening of the sprayed concrete or the sprayed mortar with the accelerator according to claim 1.

20. The method of claim 19, wherein the substrate comprises at least one of tunnel surfaces, mine surfaces, construction trenches or shafts.
